(19) United States
(12) Patent Application Publication
(10) Pub. No.: US 2017/0141430 A1
(43) Pub. Date: May 18, 2017

(54) HYBRID SOLID SINGLE-ION-CONDUCTING ELECTROLYTES FOR ALKALI BATTERIES

(71) Applicants: The University of North Carolina at Chapel Hill, Chapel Hill, NC (US); The Regents of the University of California, Oakland, CA (US)

(72) Inventors: Nitash P. Balsara, El Cerrito, CA (US); Irune Villaluenga, Berkeley, CA (US); Dominica H.C. Wong, Johnson City, TN (US); Joseph M. DeSimone, Monte Sereno, CA (US)

(21) Appl. No.: 15/341,417

(22) Filed: Nov. 2, 2016

Related U.S. Application Data
(63) Continuation of application No. PCT/US2016/033315, filed on May 19, 2016.
(60) Provisional application No. 62/254,486, filed on Nov. 12, 2015.
(60) Provisional application No. 62/165,079, filed on May 21, 2015.

(51) Int. Cl. H01M 10/0565; H01M 10/42; H01M 10/0562

(52) U.S. Cl. CPC H01M 10/0565; H01M 10/0562; H01M 10/4235; H01M 2300/0091

(57) ABSTRACT

Solid electrolyte compositions are described. The solid electrolyte compositions may include a composite including an inorganic solid electrolyte and an ion conducting fluoropolymer. A cation transference number of each of the inorganic solid electrolyte and the ion conducting fluoropolymer may be at least 0.9. The inorganic solid electrolyte may be bonded to the ion conducting fluoropolymer. Optionally, an alkali metal salt may be included in the solid electrolyte compositions. Batteries containing such solid electrolyte compositions are also described.

### RELATED APPLICATIONS

This application is a continuation of PCT Application PCT/US2016/033315, filed May 19, 2016, which claims the benefit of U.S. Provisional Applications Ser. No. 62/254,486, filed Nov. 12, 2015, and 62/165,079, filed May 21, 2015, the disclosures of each of which are incorporated by reference herein in their entirety

### STATEMENT OF FEDERAL SUPPORT

This invention was made with government support under Contract No. DE-AC02-05CH11231 awarded by the U.S. Department of Energy. The government has certain rights in the invention.

### FIELD OF THE INVENTION

The present invention concerns hybrid solid electrolyte compositions for use in batteries such as lithium-ion batteries, lithium-air batteries, and sodium-air batteries.

### BACKGROUND OF THE INVENTION

Electrolytes used in lithium-ion batteries that power personal electronic devices and electric vehicles comprise lithium salts dissolved in flammable organic liquids. Catastrophic battery failure may result in combustion of the flammable electrolyte. In addition, side-reactions between the electrolytes and anode particles result in steady capacity fade. Some of the byproducts of side-reactions can dissolve in the electrolyte and migrate from one electrode to the other. This effect may be minimized in the case of solid electrolytes due to limited solubility and slow diffusion. Mixtures of liquids and salts have additional limitations. The passage of current results in an accumulation of salt in the vicinity of one electrode and depletion close to the other electrode, because only the cation participates in the electrochemical reactions. Both over-concentrated and depleted electrolytes have lower conductivity, and this accentuates cell polarization and reduces power capability.

Solid electrolytes such as inorganic sulfide glasses (Li₂S—P₂S₅) are single-ion-conductors with high shear moduli (18-25 GPa) and high ionic conductivity (over 10⁻⁴ S/cm) at room temperature. However, these materials, on their own, cannot serve as efficient electrolytes as they cannot adhere to moving boundaries of the active particles in the battery electrode as they are charged and discharged. Hayashi et al. prepared hybrid electrolytes by mixing sulfide glasses and poly(ethylene oxide) (PEO) polymers (Hayashi, A.; Harayama, T.; Mizuno, F.; Tatsumisago, M. J. Power Sources 2006, 163, 289-293). While this improves mechanical flexibility, there is a dramatic decrease in ionic conductivity due to the PEO insulative nature. For example, the addition of 17 weight percent, wt. %, of PEO (Molecular weight, Mw, of 400 g/mol) results in hundred fold decrease in the ionic conductivity.

### BRIEF DESCRIPTION OF THE DRAWINGS

FIG. 1. (a) Synthesis of the hybrid electrolyte 77(75Li₂S.25P₂S₅).23PFPE (r=0.04) by mechanochemical reaction. (b) Characteristics of a glass pellet electrolyte, a hybrid pellet electrolyte, a hybrid membrane electrolyte and a liquid electrolyte as described in the Examples.

FIG. 2. ³¹P-NMR spectra of (a) the inorganic sulfide glass electrolyte (75Li₂S.25P₂S₅) and (b) the hybrid electrolyte (77(75Li₂S.25P₂S₅).23PFPE (r=0.04)).

FIG. 3. ¹⁹F-NMR spectra of (a) the liquid electrolyte (PFPE-diol/LiTFSI (r=0.04)) and (b) the hybrid electrolyte (77(75Li₂S.25P₂S₅).23PFPE (r=0.04)). (c) Chemical shifts of ¹⁹F-NMR of the liquid electrolyte and the hybrid electrolyte.

FIG. 4. SEM images of (a, b) the sulfide glass pellet and (c, d) the hybrid electrolyte membrane.

FIG. 5. (a) SEM image of the hybrid membrane. (b) Elemental maps of Sulfur (S), (c) Phosphorus (P) and (d) Fluorine (F). (e) Electron spectrum of the hybrid membrane.

FIG. 6. Frequency (ω) dependency of () storage (G′) and (∘) loss (G″) modulus for hybrid electrolyte measured at 30° C.

FIG. 7. Ionic conductivity, σ, as a function of the inverse of the temperature. () Glass pellet, (▴) hybrid membrane, (∘) glass pellet from Minami et al., and (⋄) PFPE-diol/LiTFSI from Wong et al. (---) Dashed curve shows the calculated conductivity of the hybrid using equation 2.

FIG. 8. Typical impedance spectrum at 30° C. of the hybrid electrolyte. (⋄) Experimental data and (-) the line corresponds to fit using the electrical equivalent circuit shown in the inset.

FIG. 9. Current density, I, as a function of time, t, for the hybrid membrane electrolyte during an 80 mV polarization at 30° C. The inset shows the ac impedance of the cell (Δ) before and (▴) after polarization.

FIG. 10. Cyclic voltammogram of the hybrid membrane electrolyte obtained at 1 mV/s at 30° C.

FIG. 11. Normalized sulfur K-edge XAS of SEO/Li₂S₈, glass pellet, and hybrid pellet exposed to lithium polysulfides. For pellet spectra, solid lines denote unexposed and dashed lines denote pellets that were pressed to the SEO/Li₂S₈ membrane for three days at 75° C.

### SUMMARY OF THE INVENTION

A first aspect of the invention is a solid electrolyte composition comprising, consisting of, or consisting essentially of a composite comprising an inorganic solid electrolyte and an ion conducting fluoropolymer, wherein a cation transference number of each of the inorganic solid electrolyte and the ion conducting fluoropolymer is at least 0.9.

In some embodiments, the cation transference number is a lithium transference number.

In some embodiments, the composition further includes an alkali metal salt.

In some embodiments, the alkali metal salt comprises a lithium salt. In some embodiments, the alkali metal salt comprises a sodium salt.

In some embodiments, the composite is included in the composition in an amount of from 90 to 99.5 percent by weight; and the alkali metal salt is included in the composition in an amount of from 0.5 to 10 percent by weight.

In some embodiments, the fluoropolymer comprises a compound selected from the group consisting of Formula I, Formula II, and mixtures thereof:

R—R_{f}—R (I)

R—R_{f} (II)

wherein:
each R is independently selected from the group consisting of —OH, —COOH, —COOR′, or —OCOOR′;

R_{f} comprises a fluoropolymer segment; and

each R′ is an independently selected hydrogen, or aliphatic, aromatic, or mixed aliphatic and aromatic group.

In some embodiments, R_{f} comprises a perfluoropolyether segment (e.g., perfluoropolyether (PFPE)).

In some embodiments, each R is selected from the group consisting of —OH and —COOH.

In some embodiments, the fluoropolymer comprises a compound of Formula I.

In some embodiments, the fluoropolymer comprises a compound of Formula II.

In some embodiments, the inorganic solid electrolyte conducts alkali ions and comprises a perovskite, a garnet, a thio-LISICON, a NASICON, a sodium super ionic conductor, an oxide glass or a sulfide glass.

In some embodiments, the perovskite comprises Li₃ₓLa_{(2/3)-x}TiO₃, the garnet comprises Li₇La₃Zr₂O₁₂, the thio-LISICON comprises Li₁₀SnP₂S₁₂, the NASICON comprises Li_{1.3}Al_{0.3}Ti_{1.7}(PO₄)₃, the sodium super ionic conductor comprises Na₁₊ₓZr₂SiₓP₃ₓO₁₂ or 50Na₂S-50P₂S₅, the oxide glass comprises Li₃BO₃—Li₂SO₄, Li₂O—P₂O₅ or Li₂O—SiO₂, and/or the sulfide glass comprises Li₂S—SiS₂ or LiI—Li₂S—B₂S₃.

In some embodiments, the inorganic solid electrolyte comprises sulfide glass comprising 75Li₂S-25P₂S₅.

In some embodiments, the alkali metal salt comprises lithium bis(trifluoromethane-sulfone)imide (LiTFSI).

In some embodiments, the fluoropolymer and the alkali metal salt together are included in the composition in an amount of about 23 percent by weight.

In some embodiments, the composition has an ionic conductivity of at least about 10⁻⁴ S/cm at room temperature (e.g., 25° C.).

In some embodiments, the composition has an electrochemical stability window up to 5V relative to Li/Li⁺ at room temperature.

In some embodiments, the composition further includes an electrode stabilizing agent.

In some embodiments, the composition is substantially free of volatile organic solvents such as carbonate solvent.

In some embodiments, the composition has a glass-transition temperature T_{g} between −120° C. and −20° C.

In some embodiments, the composition does not ignite when heated to a temperature of 235° C. and then contacted to a flame for 15 seconds in a Kohler open cup rapid flash test apparatus.

In some embodiments, the fluoropolymer is amorphous.

In some embodiments, the composition is a flexible solid.

In some embodiments, the composition is in the form of a film.

In some embodiments, the fluoropolymer does not solvate polysulfides.

A second aspect of the invention is a solid electrolyte composition, comprising, consisting of, or consisting essentially of: (a) a composite comprising an inorganic solid electrolyte bonded to a fluoropolymer; and (b) optionally, an alkali metal salt.

A further aspect of the invention is a battery, comprising: (a) an anode; (b) a cathode; and (c) a solid electrolyte composition operatively associated with the anode and cathode, wherein the electrolyte composition comprises a composition as described above.

In some embodiments, the cathode comprises a sulfur cathode.

### DETAILED DESCRIPTION OF ILLUSTRATIVE EMBODIMENTS

“Alkyl” as used herein alone or as part of another group, refers to a straight or branched chain hydrocarbon containing from 1 to 10, 20, or 30 or more carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl, and the like. “Lower alkyl” as used herein is a subset of alkyl and refers to a straight or branched chain hydrocarbon group containing from 1 to 4 carbon atoms. Representative examples of lower alkyl include, but are not limited to, methyl, ethyl, n-propyl, iso-propyl, n-butyl, iso-butyl, tert-butyl, and the like. The term “akyl” or “loweralkyl” is intended to include both substituted and unsubstituted alkyl or loweralkyl unless otherwise indicated and these groups may be substituted with additional organic and/or inorganic groups, including but not limited to groups selected from halo (e.g., to form haloalkyl), alkyl, haloalkyl, alkenyl, alkynyl, cycloalkyl, cycloalkylalkyl, aryl, arylalkyl, heterocyclo, heterocycloalkyl, hydroxyl, alkoxy (thereby creating a polyalkoxy such as polyethylene glycol), fluoropolymer (including perfluoropolymers, fluoropolyethers, and perfluoropolyethers), alkenyloxy, alkynyloxy, haloalkoxy, cycloalkoxy, cycloalkylalkyloxy, aryloxy, arylalkyloxy, heterocyclooxy, heterocyclolalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, carboxy, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, acylamino, acyloxy, ester, amide, sulfonamide, urea, alkoxyacylamino, aminoacyloxy, nitro or cyano where m=0, 1, 2 or 3.

“Alkenyl” as used herein alone or as part of another group, refers to a straight or branched chain hydrocarbon containing from 1 to 10, 20, or 30 or more carbon atoms (or in loweralkenyl 1 to 4 carbon atoms) which include 1 to 4, 5 or 6 or more double bonds in the normal chain. Representative examples of alkenyl include, but are not limited to, vinyl, 2-propenyl, 3-butenyl, 2-butenyl, 4-pentenyl, 3-pentenyl, 2-hexenyl, 3-hexenyl, 2,4-heptadiene, and the like. The term “alkenyl” or “loweralkenyl” is intended to include both substituted and unsubstituted alkenyl or loweralkenyl unless otherwise indicated and these groups may be substituted with groups as described in connection with alkyl and loweralkyl above.

“Alkynyl” as used herein alone or as part of another group, refers to a straight or branched chain hydrocarbon containing from 1 to 10, 20, 30 or 40 or more carbon atoms (or in loweralkynyl 1 to 4 carbon atoms) which include 1, 2, or 3 or more triple bonds in the normal chain. Representative examples of alkynyl include, but are not limited to, 2-propynyl, 3-butynyl, 2-butynyl, 4-pentynyl, 3-pentynyl, and the like. The term “alkynyl” or “loweralkynyl”—is intended to include both substituted and unsubstituted alkynyl or loweralknynyl unless otherwise indicated and these groups may be substituted with the same groups as set forth in connection with alkyl and loweralkyl above.

“Aryl” as used herein alone or as part of another group, refers to a monocyclic carbocyclic ring system or a bicyclic carbocyclic fused ring system having one or more aromatic rings. Representative examples of aryl include, azulenyl, indanyl, indenyl, naphthyl, phenyl, tetrahydronaphthyl, and the like. The term “aryl” is intended to include both substituted and unsubstituted aryl unless otherwise indicated and these groups may be substituted with the same groups as set forth in connection with alkyl and loweralkyl above.

“Cycloalkyl” as used herein alone or as part of another group, refers to a saturated or partially unsaturated cyclic hydrocarbon group containing from 3, 4 or 5 to 6, 7 or 8 carbons (which carbons may be replaced in a heterocyclic group as discussed below). Representative examples of cycloalkyl include, cyclopropyl, cyclobutyl, cyclopentyl, cyclohexyl, cycloheptyl, and cyclooctyl. These rings may be optionally substituted with additional substituents as described herein such as halo or loweralkyl. The term “cycloalkyl” is generic and intended to include heterocyclic groups as discussed below unless specified otherwise.

“Heterocyclo” as used herein alone or as part of another group, refers to an aliphatic (e.g., fully or partially saturated heterocyclo) or aromatic (e.g., heteroaryl) monocyclic- or a bicyclic-ring system. Monocyclic ring systems are exemplified by any 5 or 6 membered ring containing 1, 2, 3, or 4 heteroatoms independently selected from oxygen, nitrogen and sulfur. The 5 membered ring has from 0-2 double bonds and the 6 membered ring has from 0-3 double bonds. Representative examples of monocyclic ring systems include, but are not limited to, azetidine, azepine, aziridine, diazepine, 1,3-dioxolane, dioxane, dithiane, furan, imidazole, imidazoline, imidazolidine, isothiazole, isothiazoline, isothiazolidine, isoxazole, isoxazoline, isoxazolidine, morpholine, oxadiazole, oxadiazoline, oxadiazolidine, oxazole, oxazoline, oxazolidine, piperazine, piperidine, pyran, pyrazine, pyrazole, pyrazoline, pyrazolidine, pyridine, pyrimidine, pyridazine, pyrrole, pyrroline, pyrrolidine, tetrahydrofuran, tetrahydrothiophene, tetrazine, tetrazole, thiadiazole, thiadiazoline, thiadiazolidine, thiazole, thiazoline, thiazolidine, thiophene, thiomorpholine, thiomorpholine sulfone, thiopyran, triazine, triazole, trithiane, and the like. Bicyclic ring systems are exemplified by any of the above monocyclic ring systems fused to an aryl group as defined herein, a cycloalkyl group as defined herein, or another monocyclic ring system as defined herein. Representative examples of bicyclic ring systems include but are not limited to, for example, benzimidazole, benzothiazole, benzothiadiazole, benzothiophene, benzoxadiazole, benzoxazole, benzofuran, benzopyran, benzothiopyran, benzodioxine, 1,3-benzodioxole, cinnoline, indazole, indole, indoline, indolizine, naphthyridine, isobenzofuran, isobenzothiophene, isoindole, isoindoline, isoquinoline, phthalazine, purine, pyranopyridine, quinoline, quinolizine, quinoxaline, quinazoline, tetrahydroisoquinoline, tetrahydroquinoline, thiopyranopyridine, and the like. These rings include quaternized derivatives thereof and may be optionally substituted with additional organic and/or inorganic groups, including but not limited to groups selected from halo, alkyl, haloalkyl, alkenyl, alkynyl, cycloalkyl, cycloalkylalkyl, aryl, arylalkyl, heterocyclo, heterocycloalkyl, hydroxyl, alkoxy, fluoropolymer (including perfluoropolymers, fluoropolyethers, and perfluoropolyethers), alkenyloxy, alkynyloxy, haloalkoxy, cycloalkoxy, cycloalkylalkyloxy, aryloxy, arylalkyloxy, heterocyclooxy, heterocyclolalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, acylamino, acyloxy, ester, amide, sulfonamide, urea, alkoxyacylamino, aminoacyloxy, nitro or cyano where m=0, 1, 2 or 3.

“Heteroaryl” as used herein is as described in connection with heterocyclo above.

“Cycloalkylalkyl,” “cycloalkylalkenyl,” and “cycloalkylalkynyl” as used herein alone or as part of another group, refers to a cycloalkyl group, as defined herein, appended to the parent molecular moiety through an alkyl, alkenyl, or alkynyl group, as defined herein. Representative examples of arylalkyl include, but are not limited to, benzyl, 2-phenylethyl, 3-phenylpropyl, 2-naphth-2-ylethyl, and the like.

“Arylalkyl,” “Arylalkenyl,” and “Arylalkynyl” as used herein alone or as part of another group, refers to an aryl group, as defined herein, appended to the parent molecular moiety through an alkyl, alkenyl, or alkynyl group, as defined herein. Representative examples of arylalkyl include, but are not limited to, benzyl, 2-phenylethyl, 3-phenylpropyl, 2-naphth-2-ylethyl, and the like.

“Heterocycloalkyl,” “heterocycloalkenyl,” and “heterocycloalkynyl” as used herein alone or as part of another group, refers to a heterocyclo group, as defined herein, appended to the parent molecular moiety through an alkyl, alkenyl, or alkynyl group, as defined herein. Representative examples of arylalkyl include, but are not limited to, benzyl, 2-phenylethyl, 3-phenylpropyl, 2-naphth-2-ylethyl, and the like.

“Alkoxy” as used herein alone or as part of another group, refers to an alkyl or loweralkyl group, as defined herein (and thus including substituted versions such as polyalkoxy), appended to the parent molecular moiety through an oxy group, —O—. Representative examples of alkoxy include, but are not limited to, methoxy, ethoxy, propoxy, 2-propoxy, butoxy, tert-butoxy, pentyloxy, hexyloxy and the like.

“Halo” as used herein refers to any suitable halogen, including —F, —Cl, —Br, and —I.

“Mercapto” as used herein refers to an —SH group.

“Cyano” as used herein refers to a —CN group.

“Formyl” as used herein refers to a —C(O)H group.

“Carboxylic acid” as used herein refers to a —C(O)OH group.

“Hydroxyl” as used herein refers to an —OH group.

“Nitro” as used herein refers to an —NO₂ group.

“Acyl” as used herein alone or as part of another group refers to a —C(O)R radical, where R is any suitable substituent such as aryl, alkyl, alkenyl, alkynyl, cycloalkyl or other suitable substituent as described herein.

“Amino” as used herein means the radical NH₂.

“Alkylamino” as used herein alone or as part of another group means the radical —NHR, where R is an alkyl group.

“Arylalkylamino” as used herein alone or as part of another group means the radical —NHR, where R is an arylalkyl group.

“Disubstituted-amino” as used herein alone or as part of another group means the radical —NRₐR_{b}, where Rₐ and R_{b} are independently selected from the groups alkyl, haloalkyl, alkenyl, alkynyl, cycloalkyl, cycloalkylalkyl, aryl, arylalkyl, heterocyclo, heterocycloalkyl.

“Acylamino” as used herein alone or as part of another group means the radical —NRₐR_{b}, where Rₐ is an acyl group as defined herein and R_{b} is selected from the groups hydrogen, alkyl, haloalkyl, alkenyl, alkynyl, cycloalkyl, cycloalkylalkyl, aryl, arylalkyl, heterocyclo, heterocycloalkyl.

“Acyloxy” as used herein alone or as part of another group means the radical —OR, where R is an acyl group as defined herein.

“Ester” as used herein alone or as part of another group refers to a —C(O)OR radical, where R is any suitable substituent such as alkyl, cycloalkyl, alkenyl, alkynyl or aryl.

“Amide” as used herein alone or as part of another group refers to a —C(O)NRₐR_{b} radical, where Rₐ and R_{b} are any suitable substituent such as alkyl, cycloalkyl, alkenyl, alkynyl or aryl.

“Sulfonyl” as used herein refers to a compound of the formula —S(O)(O)R, where R is any suitable substituent such as alkyl, cycloalkyl, alkenyl, alkynyl or aryl.

“Sulfonate” as used herein refers to a compound of the formula —S(O)(O)OR, where R is any suitable substituent such as alkyl, cycloalkyl, alkenyl, alkynyl or aryl.

“Sulfonamide” as used herein alone or as part of another group refers to a —S(O)₂NRₐR_{b} radical, where Rₐ and R_{b} are any suitable substituent such as H, alkyl, cycloalkyl, alkenyl, alkynyl or aryl.

“Urea” as used herein alone or as part of another group refers to an —N(R_{c})C(O)NRₐR_{b} radical, where Rₐ, R_{b} and R_{c} are any suitable substituent such as H, alkyl, cycloalkyl, alkenyl, alkynyl or aryl.

“Alkoxyacylamino” as used herein alone or as part of another group refers to an —N(Rₐ)C(O)OR_{b} radical, where Rₐ, R_{b} are any suitable substituent such as H, alkyl, cycloalkyl, alkenyl, alkynyl or aryl.

“Aminoacyloxy” as used herein alone or as part of another group refers to an —OC(O)NRₐR_{b} radical, where Rₐ and R_{b} are any suitable substituent such as H, alkyl, cycloalkyl, alkenyl, alkynyl or aryl.

“Fluoropolymers” and “perfluoropolymers” are known. “Fluoropolymer” as used herein alone or as part of another group refers to a branched or unbranched fluorinated chain including one or more C—F bonds. The term “perfluorinated” as used herein refers to a compound or part thereof that is fully fluorinated with no C—H bonds. “Perfluoropolymer” as used herein alone or as part of another group refers to a fluorinated chain that includes multiple C—F bonds and no C—H bonds. Examples of fluoropolymers include but are not limited to fluoropolyethers and perfluoropolyethers, poly(perfluoroalkyl acrylate), poly(perfluoroalkyl methacrylate), polytetrafluoroethylene, polychlorotrifluoroethylene, polyvinylidene fluoride, etc. See, e.g., U.S. Pat. Nos. 8,361,620; 8,158,728 (DeSimone et al.); and U.S. Pat. No. 7,989,566.

“Fluoropolyethers,” including partially fluorinated polyethers and fully fluorinated polyethers (perfluoropolyethers) are known. Examples include but are not limited to polymers that include a segment such as a difluoromethylene oxide, tetrafluoroethylene oxide, hexafluoropropylene oxide, tetrafluoroethylene oxide-co-difluoromethylene oxide, hexafluoropropylene oxide-co-difluoromethylene oxide, or a tetrafluoroethylene oxide-co-hexafluoropropylene oxide-co-difluoromethylene oxide segments and combinations thereof. See, e.g., U.S. Pat. No. 8,337,986. Additional examples include but are not limited to those described in P. Kasai et al., Applied Surface Science 51, 201-211 (1991); J. Pacansky and R. Waltman, Chem. Mater. 5, 486-494 (1993); K. Paciorek and R. Kratzer, Journal of Fluorine Chemistry 67, 169-175 (1994); M. Proudmore et al., Journal of Polymer Science: Part A: Polymer Chemistry, 33, 1615-1625 (1995); J. Howell et al., Journal of Fluorine Chemistry 125, 1513-1518 (2004); and in U.S. Pat. Nos. 8,084,405; 7,294,731; 6,608,138; 5,612,043; 4,745,009; 4,178,465; etc.

The term “bonded” as used herein means chemically bonded, preferably by a strong chemical bond such as a covalent bond or ionic bond, rather than a weaker chemical bond such as a hydrogen bond or van der Walls attraction (for example, a bond energy of at least 10, 20, 40 or 60 kcal/mol, up to 200, 300 or 400 kcal/mol or more).

### A. Fluoropolymers

Suitable fluoropolymers for use in the present invention include compounds of Formula I, Formula II, and mixtures thereof (e.g., including two or more different compounds both of general Formula I, one or more compound of general formula I and one or more compound of general Formula II, two or more different compounds of general Formula II):

R—R_{f}R (I)

R—R_{f} (II)

wherein:

each R is independently selected from the group consisting of —OH, —COOH, —COOR′, or —OCOOR′;

R_{f} is a fluoropolymer segment (e.g., a fluoropolyether segment such as a perfluoropolyether segment) having a weight average molecular weight of from 0.2, 0.4 or 0.5 to 5, 10 or 20 Kg/mol; and

each R′ is independently selected aliphatic, aromatic, or mixed aliphatic and aromatic groups (e.g., are each independently selected from the group consisting of alkyl, alkenyl, alkynyl, cycloalkylalkyl, cycloalkylalkenyl, cycloalkylalkynyl, arylalkyl, arylalkenyl, arylalkynyl, heterocycloalkyl, heterocycloalkenyl, heterocycloalkynyl, etc., including fluoropolymers as given in connection with R_{f}, polyethers such as polyethylene glycol (PEG), polyether carbonates such as PEG carbonate, etc.).

In some embodiments, R_{f} includes a perfluoropolyether segment with a linking group, such as —CH₂ or other lower alkyl segment, to R. The perfluoropolyether segment may provide most of the weight of R_{f}. Compounds according to Formula I and Formula II that have a central PFPE segment (Formula I) or terminal PFPE segment (Formula II) are referred to as functionalized PFPE's or PFPE's terminated with functional groups.

As noted above, in some embodiments, the fluoropolymers include perfluoropolymer segments. Examples of such fluoropolymers include hydroxy-terminated perfluoropolyethers (PFPE-diol) of the following formula with M_{w} of the PFPE segment=100 or 200 to 5,000 or 10,000, e.g., 1,000 g/mol:

OH—CH₂—CF₂OCF₂CF₂Oₓ—CF₂O_{y}—CF₂—CH₂—OH

where x and y are integers that yield the weight average molecular weight M_{W} given above.

In some embodiments, the fluoropolymers are —COOH-terminated perfluoropolyethers with M_{w} of the PFPE segment=100 or 200 to 5,000 or 10,000, e.g., 1,000 g/mol. In some embodiments, the fluoropolymers are —COOR′-terminated perfluoropolyethers with M_{w} of the PFPE segment=100 or 200 to 5,000 or 10,000, e.g., 1,000 g/mol. In some embodiments, the fluoropolymers are —OCOOR′-terminated perfluoropolyethers with M_{w} of the PFPE segment=100 or 200 to 5,000 or 10,000, e.g., 1,000 g/mol.

The fluoropolymers described herein for use in electrolyte compositions conduct alkali ions, for example lithium or sodium ions. As described further below, in some embodiments, the fluoropolymers are characterized by having high cation transference numbers. For example, in some embodiments, the fluoropolymers have lithium transference numbers of at least 0.9. Fluoropolymers according to Formula I and having lithium transference numbers of 0.95 and higher are described in Wong, D. H. C.; Thelen, J. L.; Fu, Y.; Devaux, D.; Pandya, A. A.; Battaglia, V. S.; Balsara, N. P.; DeSimone, J. M. PNAS 2014, 111, 3327-3331), incorporated by reference herein.

### B. Inorganic Electrolytes.

Any inorganic electrolytes that are solid and conduct alkali ions (for example, lithium or sodium ions) may be used in the electrolyte compositions described herein. These inorganic electrolytes are typically in the form of particles. The inorganic electrolytes may be glass, glass-ceramic, or ceramic particles in certain embodiments.

Examples of solid lithium ion conductors include thio-LISICON (e.g., Li₁₀SnP₂S₁₂), garnet (e.g., Li₇La₃Zr₂O₁₂), perovskite (e.g., Li₃ₓLa_{(2/3)-x}TiO₃), NASICON (e.g., Li_{1.3}Al_{0.3}Ti_{1.7}(PO₄)₃) and glass-ceramic (e.g., xLi₂S.(1−x)P₂S₅) materials. In some embodiments, sodium super ionic conductors (e.g., Na₁₊ₓZr₂SiₓP₃₋ₓO₁₂, 50Na₂S-50P₂S₅) may be used.

Further examples of inorganic solid lithium ion conductors are described in Inorganic solid lithium ion conductors Cao, C.; Li, Z.; Wang, X.; Zhao, X; Han, W. Front. Energy Res. 2:25. doi:10.3389/fenrg.2014.00025), which is incorporated by reference herein.

In some embodiments, inorganic electrolytes may be glass electrolytes such as oxide glasses (e.g., Li₃BO₃—Li₂SO₄, Li₂O—P₂O₅, Li₂O—SiO₂) and sulfide glasses (e.g., Li₂S—SiS₂, LiI—Li₂S—B₂S₃, 75Li₂S.25P₂S₅). Further examples of such glass electrolytes are disclosed in Ribes, M.; Barrau, B.; Souquet, J. L. J. Non-Cryst. Solids 1980, 38 &39, 271-276; Minami, T. J. Non-Cryst. Solids 1987, 95 & 96, 107-118; Hayashi, A.; and Tatsumisago, M. Abstract #1188, Honolulu PRiME 2012, The Electrochemical Society, which are incorporated by reference herein.

The inorganic electrolytes may be fabricated by any appropriate method. For example, crystalline materials may be obtained using different synthetic methods such as sol-gel and solid state reactions. Glass electrolytes may be obtain by mechanical milling as described in Tatsumisago, M.; Takano, R.; Tadanaga K.; Hayashi, A. J. Power Sources 2014, 270, 603-607, incorporated by reference herein.

### C. Electrolyte Compositions.

According to various embodiments, the electrolyte compositions described herein are solid electrolyte compositions including an inorganic electrolyte and a fluoropolymer. The solid electrolyte compositions may be characterized as hybrid or composite compositions that include an inorganic phase and an organic polymer phase. As described above, the inorganic phase is typically in the form of ion-conducting particles. The polymer phase may be an ion-conducting fluoropolymer as described above. In some embodiments, the ion-conducting particles are dispersed in a fluoropolymer matrix. In some embodiments, the inorganic electrolyte is bonded to the fluoropolymer. In some embodiments, the inorganic electrolyte is not bonded to the fluoropolymer. If bonded, the bonds may be any one or more of covalent, ionic, van der Waals or hydrogen bonds.

The electrolyte compositions can be prepared by any suitable technique, such as mechanical milling. A mechanical milling technique is described below in the Examples. Other techniques for forming the solid composite electrolytes may be used.

The electrolyte compositions may also include alkali metal ion salts. Alkali metal ion salts that can be used are also known or will be apparent to those skilled in the art. Any suitable salt can be used, including both lithium salts and sodium salts, and potassium salts. That is, salts containing lithium or sodium or potassium as a cation, and an anion, may be used. Any suitable anion may be used, examples of which include, but are not limited to, boron tetrafluoride, aluminate, (oxalate)borate, difluoro(oxalate)borate, phosphorus hexafluoride, alkylsulfonate, fluoroalkylsulfonate, arylsulfonate, bis(alkylsulfonyl)amide, perchlorate, bis(fluoroalkylsulfonyl)amide, bis(arylsulfonyl)amide, alkyl fluorophosphate, (fluoroalkylsulfonyl) (fluoroalkylcarbonyl) amide, halide, nitrate, nitrite, sulfate, hydrogen sulfate, alkyl sulfate, aryl sulfate, carbonate, bicarbonate, carboxylate, phosphate, hydrogen phosphate, dihydrogen phosphate, hypochlorite, an anionic site of a cation-exchange resin, lithium bis (trifluoromethane-sulfone)imide (LiTFSI) and a mixture of any two or more thereof.

The alkali metal salt may be included in the hybrid solid compositions in any suitable amount, typically between about 0.5 or 10 percent by weight. In some embodiments, however, the amount may be up to 20 or 30 percent by weight. Likewise, the composite including an inorganic electrolyte and an ion-conducting polymer may be included in the composition in any suitable amount, typically from 90% or 95% to 99.5% by weight. However, in some embodiments, the composite may be included in an amount from 70 or 75 percent by weight up to 85, 90 or 95 percent by weight.

The fluoropolymer may be included in the hybrid solid composite in an amount ranging from about 10, 15, or 20 to about 25, 30 or 40 percent by weight, with the inorganic phase being present in an amount ranging from about 60, 70, or 75 percent to 80, 85 or 90 percent by weight.

The solid composite electrolyte may be provided in the form of a pellet, a compressed pellet, or a membrane, or any other suitable form.

If desired, an electrode stabilizing agent can be added to or included in the electrolyte compositions (in some embodiments before cross-linking thereof), in accordance with known techniques. See, e.g., Zhang et al., US Pat. App. Pub No. 2012/0082903. For example, the electrolytes can include an electrode stabilizing additive that can be reduced or polymerized on the surface of a negative electrode to form a passivation film on the surface of the negative electrode. Likewise, the electrolytes can include an electrode stabilizing additive that can be oxidized or polymerized on the surface of the positive electrode to form a passivation film on the surface of the positive electrode. In some embodiments, electrolytes can include mixtures of the two types of electrode stabilizing additives. The additives are typically present at a concentration of about 0.001 to 8 wt %. For example, an electrode stabilizing additive can be a substituted or unsubstituted linear, branched or cyclic hydrocarbon comprising at least one oxygen atom and at least one aryl, alkenyl or alkynyl group. The passivating film formed from such electrode stabilizing additives may also be formed from a substituted aryl compound or a substituted or unsubstituted heteroaryl compound where the additive comprises at least one oxygen atom. Numerous particular examples are described in Zhang et al. at paragraphs 173-174 therein. For solid electrolytes as described herein, an additive may be added at the electrolyte-electrode interface.

If desired, fillers or conductivity enhancers may optionally be included in the electrolyte compositions. Examples include but are not limited to include but are not limited to Al₂O₃, AlOOH, BaTiO₃, BN, LiN₃ LiAlO₂, lithium fluorohectorite, and/or fluoromica clay. In some embodiments, these may added as dopants to the inorganic phase. Additives such as hexamethyldisilazane (HMDS) may also be included to improve interfacial resistance in a lithium cell and trap (react) with any available water and that may be present and detrimental to cell performance. See, US Patent App. Pub. No. 2011/0311881 at paragraphs 87-88.

### D. Transference Numbers

The transference number of an ion in an electrolyte is the fraction of total current carried in the electrolyte for the ion. Single-ion conductors have a transference number close to unity. The solid electrolyte composites described herein are single ion conductors, and have a transference number close to unity.

While inorganic electrolytes typically have transference numbers close to unity, the lithium transference numbers of polymers such as PEO are around 0.3. Interfaces between single-ion-conductors and conventional electrolytes having low transference numbers may result in prohibitively large interfacial impedances. In addition to lose single-ion-conduction, conventional hybrids of inorganic single-ion-conductors and conventional electrolytes containing salt may not have suitable ionic conductivities for battery operation. If the polymer weight fraction is reduced to 2 wt. % then no decrease in the ionic conductivity is measured, but it is unlikely that the mechanical properties of such a composite would differ substantially from a pure glass electrolyte. The conductivity of the polymeric phase in the electrolyte may be improved by the addition of salt but then hybrid is no longer a single-ion-conductor.

Both the inorganic and organic phases of the composite materials described herein are single ion conductors with high transference numbers. As such, the solid electrolyte composites are single-ion conductors.

In some embodiments, the solid electrolyte composites including an inorganic ion-conducting phase and an organic ion-conducting phase may be characterized by having a transference number of at least 0.9, and in some embodiments, at least 0.95, at least 0.98, or at least 0.99. Further, the polymer phase may be at least 10 wt % of the composite. In some embodiments, the solid electrolyte composites may be characterized by having an organic polymer phase with a transference number matched to that of the inorganic phase, e.g., such that the difference is no more than 0.1 or 0.05.

As noted above, PFPE's according to Formula I having high lithium transference numbers are described in Wong, D. H. C.; Thelen, J. L.; Fu, Y.; Devaux, D.; Pandya, A. A.; Battaglia, V. S.; Balsara, N. P.; DeSimone, J. M. PNAS 2014, 111, 3327-3331), incorporated by reference herein.

Transference number measurements are described in S. Zugmanna, l, M. Fleischmannb, M. Amerellera, R. M. Gschwindb, H. D. Wiemhoferc, H. J. Goresa, Electrochimica Acta 56 (2011) 3926-3933, incorporated by reference herein, and may be made as in that reference or as described below in Example 4.

### E. Alkali Metal Batteries.

An alkali metal battery (sometimes also referred to as alkali metal ion batteries, and including alkali metal-air batteries) of the present invention generally includes (a) an anode; (b) a cathode; (c) a hybrid solid electrolyte composition as described above operatively associated with the anode and cathode, and (d) optionally a separator for physically separating the anode and cathode (See, e.g., M. Armand and J.-M. Tarascon, Building Bettery Batteries, Nature 451, 652-657 (2008), incorporated by reference herein). Examples of suitable battery components include but are not limited to those described in U.S. Pat. Nos. 5,721,070; 6,413,676; 7,729,949; and 7,732,100, and in US Patent Application Publication Nos. 2009/0023038; 2011/0311881; and 2012/0082930; and S.-W. Kim et al., Adv. Energy Mater. 2, 710-721 (2012), incorporated by reference herein.

Examples of suitable anodes include but are not limited to anodes formed of lithium metal, lithium alloys, sodium metal, sodium alloys, carbonaceous materials such as graphite, and combinations thereof. Numerous carbon electrode materials, including but not limited to carbon foams, fibers, flakes, nanotubes and other nanomaterials, etc., alone or as composites with each other or other materials, are known and described in, for example, U.S. Pat. Nos. 4,791,037; 5,698,341; 5,723,232; 5,776,610; 5,879,836; 6,066,413; 6,146,791; 6,503,660; 6,605,390; 7,071,406; 7,172,837; 7,465,519; 7,993,780; 8,236,446, and 8,404,384. Examples of suitable cathodes include, but are not limited to cathodes formed of transition metal oxides, doped transition metal oxides, metal phosphates, metal sulfides, lithium iron phosphate, sulfur and combinations thereof. In some embodiments, the cathode may be a sulfur cathode. See, e.g., U.S. Pat. No. 7,722,994. Additional examples include but are not limited to those described in Zhang et al., US Pat. App. Pub No. 2012/0082903, at paragraphs 178 to 179. In some embodiments, an electrode such as a cathode can be a liquid electrode, such as described in Y. Lu et al., J. Am. Chem. Soc. 133, 5756-5759 (2011). In an alkali metal-air battery such as a lithium-air battery, sodium-air battery, or potassium-air battery, the cathode is preferably permeable to oxygen (e.g., mesoporous carbon, porous aluminum, etc.), and the cathode may optionally contain a metal catalyst (e.g., manganese, cobalt, ruthenium, platinum, or silver catalysts, or combinations thereof) incorporated therein to enhance the reduction reactions occurring with lithium ion and oxygen at the cathode. See, e.g., U.S. Pat. No. 8,012,633 and US Patent Application Publication Nos. 2013/0029234; 2012/0295169; 2009/0239113; see also P. Hartmann et al., A rechargeable room-temperature sodium superoxide (NaO₂) battery, Nature Materials 12, 228-232 (2013).

A separator formed from any suitable material permeable to ionic flow can also be included to keep the anode and cathode from directly electrically contacting one another. However, as the electrolyte compositions described herein are solid compositions, they can serve as separators, particularly when they are in the form of a film. Examples of suitable separators include, but are not limited to, porous membranes or films formed from organic polymers such as polypropylene, polyethylene, etc., including composites thereof. See generally P. Arora and Z. Zhang, Battery Separators, Chem. Rev. 104, 4419-4462 (2004). The solid film electrolyte compositions of the present invention may be of any suitable thickness depending upon the particular battery design, such as from 0.01, 0.02, 0.1 or 0.2 microns thick, up to 25, 30, or 50 microns thick, or more.

All components of the battery can be included in or packaged in a suitable rigid or flexible container with external leads or contacts for establishing an electrical connection to the anode and cathode, in accordance with known techniques.

The present invention is explained in greater detail in the following non-limiting Examples.

### Example 1

### Materials and Hybrid Electrolyte Preparation

Reagent-grade Li₂S (99.9%) and P₂S₅ (99%) were purchased from Aldrich. Hydroxy-terminated perfluoropolyether as shown above (PFPE-diol, M_{w}=1000 g/mol) was purchased from Solvay and lithium bis(trifluoromethanesulfone)imide (LiTFSI), was purchased from Novolyte. All chemicals were used as received.

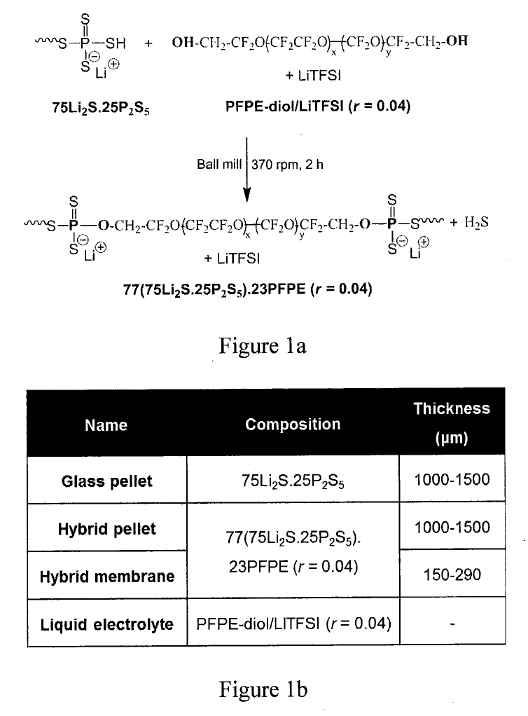

Predetermined amounts of crystalline Li₂S and P₂S₅ powders were used as starting materials to get 75Li₂S.25P₂S₅ (mol %) by ball milling. The powders were placed in a zirconia jar (volume of 45 mL) with 8 zirconia balls (10 mm in diameter). A glassy powder was obtained after mechanical milling for 15 h at 510 rpm and room temperature under argon. Single-ion-conducting hybrid solid electrolytes were prepared by conducting mechanochemical reaction between sulfide glass (75Li₂S.25P₂S5), hydroxy-terminated PFPE (PFPE-diol, average molecular weight 1 kg/mol), and lithium bis(trifluoromethane) sulfonimide (LiTFSI) in a planetary ball mill. The process was similar to that reported by Hayashi, A.; Harayama, T.; Mizuno, F.; Tatsumisago, M. J. Power Sources 2006, 163, 289-293, incorporated by reference herein. The molar ratio, r, of Li+ ions to perfluoroalkylene oxide moieties in the chain was fixed at 0.04. FIG. 1a illustrates the mechanochemical reaction. Reactions between lithiated phosphorus sulfide groups in the glass and hydroxyl groups on PFPE-diol results in a glass-PFPE composite with the elimination of H₂S. The final product is a hybrid solid electrolyte made of (77(75Li₂S.25P₂S₅).23PFPE (r=0.04)) (23 wt. % PFPE-diol/LiTFSI).

Three samples, which are named: glass pellet, hybrid pellet, and hybrid membrane, were prepared. In addition, a liquid electrolyte comprising a mixture of PFPE-diol and LiTFSI with r=0.04 was prepared using the method described in Wong et al. (Wong, D. H. C.; Thelen, J. L.; Fu, Y.; Devaux, D.; Pandya, A. A.; Battaglia, V. S.; Balsara, N. P.; DeSimone, J. M. PNAS 2014, 111, 3327-3331). The compositions of all three electrolytes are provided in FIG. 1b.

### Example 2

### Characterization of Glass and Hybrid Electrolytes

¹⁹F and ³¹P NMR spectra were obtained on a Bruker Advance 400 and 600 spectrometer in CDCl₃ or deuterated THF-d₈. The morphological characterization of the sulfide glass pellets and hybrid membranes were accomplished by scanning electron microscope with energy dispersive x-ray spectroscopy (SEM/EDS). All the samples were prepared and measured under argon. SEM experiments were performed on a JEOL-7500F field emission microscope with an accelerating voltage of 5 kV for SEM measurements and of 10 kV for EDS measurements. For linear rheology measurements, a hybrid pellet of 8 mm diameter and 1.5 mm thickness was prepared using the same method as the hybrid pellets for conductivity measurements. The rheology measurements were performed in a Rheometric Scientific ARES Rheostat. The rheometer platens were cleaned and heated to 30° C. under nitrogen. The platen gap position was zeroed and then the sample was placed between the platens. The platens were then heated to 30° C. and the sample was left to equilibrate for 1 h. At each measurement temperature, a dynamic strain test was performed at a frequency of 10 rad/s to ensure measurement in the linear regime. Then a dynamic frequency test was performed at a low strain in the linear regime.

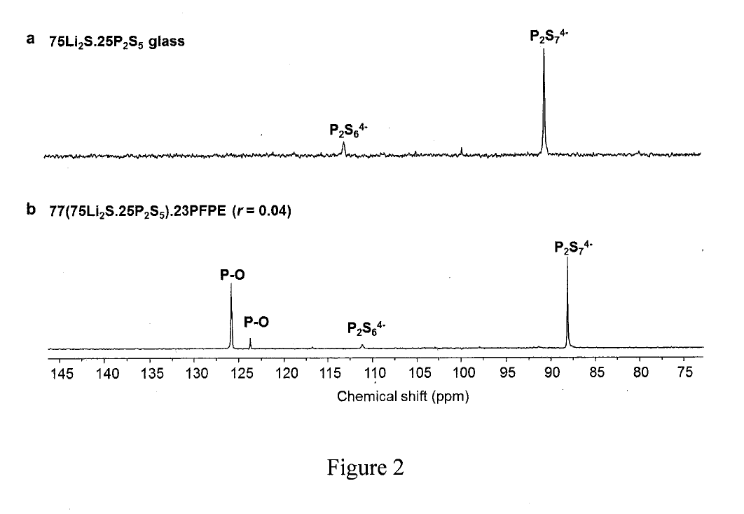

FIG. 2a shows ³¹P-NMR spectra of the pure glass and hybrid electrolyte obtained by ball milling. ³¹P-NMR spectrum of the glass shows two peaks at 90 and 113 ppm. The ³¹P-NMR spectrum of the hybrid electrolyte shows two new peaks at 124 and 126 ppm, which are not present in the pure glass. These peaks are attributed to P—O bonds and confirm the reaction between the PSH groups of the glass and the OH groups of PFPE-diol polymer. The two peaks at 124 and 126 ppm in FIG. 2b indicate the presence of two chemical environments.

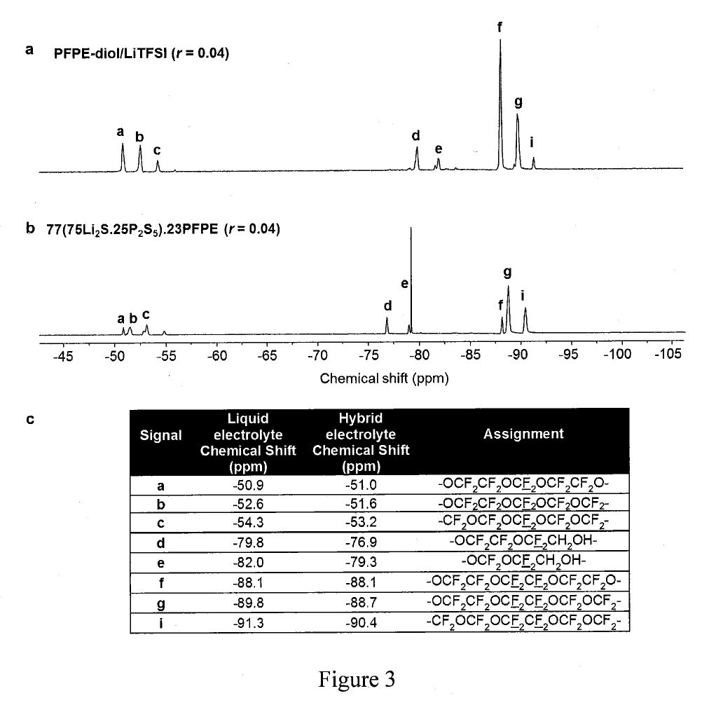

¹⁹F-NMR measurements were performed to ensure that ball milling did not degrade the PFPE polymer. FIG. 3a shows the NMR spectrum of the neat liquid electrolyte while FIG. 3b shows the NMR spectrum of a suspension of the hybrid electrolyte in deuterated THF-d₈. The spectra are similar, indicating that PFPE chains remain intact during the milling process. FIG. 3c shows the peak position obtained from these two systems. The biggest differences in the chemical shifts are seen in the fluorine atoms near the chain ends (signals d and e), and this may be because of the presence of P—O bonds due to the reaction with the glass.

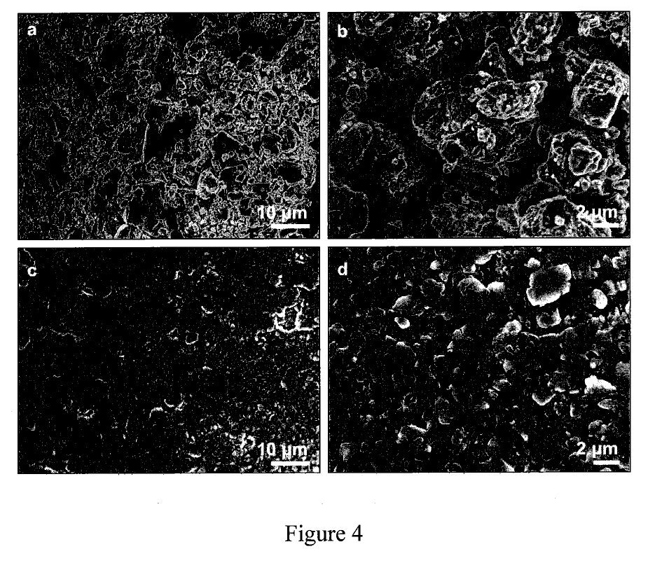

The morphologies of the surfaces of sulfide glass pellet and hybrid membrane were studied by SEM and the results are shown in FIG. 4. The glass pellet (FIGS. 4a and 4b) shows 1 to 10 μm sized particles with voids between the particles. The hybrid membrane (FIGS. 4c and 4d) exhibits much smaller particles with relatively few voids. Accordingly, significantly faster ion transport in the hybrid membrane is expected due to the lower void fraction.

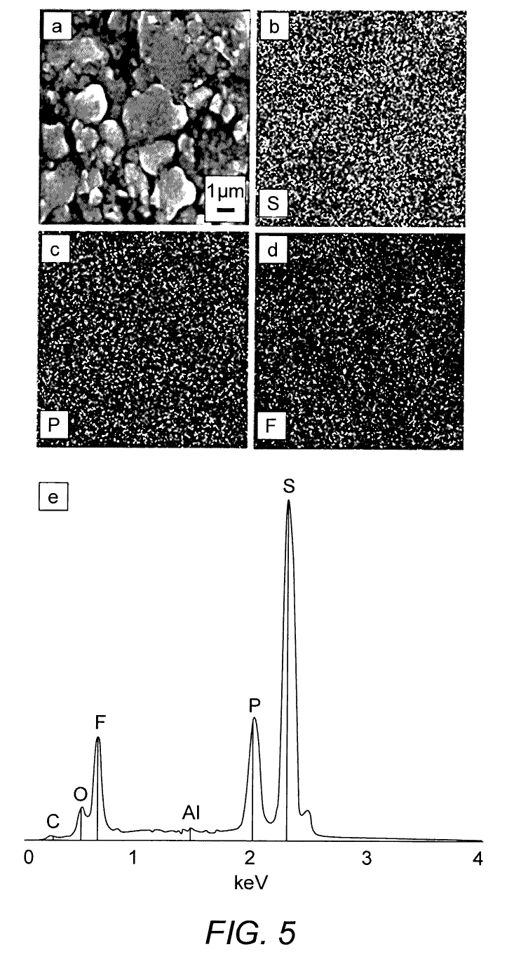

SEM/EDS images were obtained to determine the morphology and chemical composition of the hybrid. FIG. 5a shows the SEM of the sample from which elemental maps was determined. The electron spectrum of the sample is shown in FIG. 5e. The spectrum is dominated by Sulfur (S), Phosphorus (P) and Fluorine (F). All three components are distributed more-or-less uniformly as shown in FIG. 5b(S), FIG. 5c(P) and FIG. 5d (F). The intensity of fluorine (FIG. 5d) is lower than sulfur and phosphorous (FIG. 5b and FIG. 5c) due to the low volume fraction of PFPE in the hybrid. These results confirm the presence PFPE chains in the hybrid and are consistent with ³¹P-NMR results.

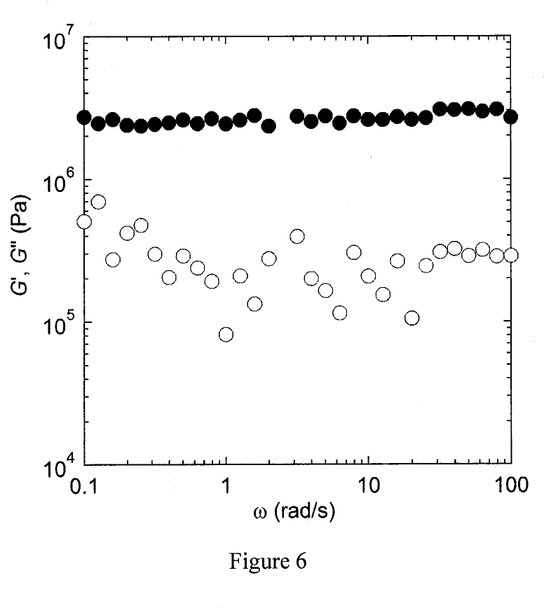

The mechanical properties of electrolytes affect the adhesion at the electrode/electrolyte interface during cycling. This is important in solid electrolytes as intimate contact between the electrolyte and active particles is essential for a functioning battery. FIG. 6 shows the frequency (co) dependency of the storage (G′) and loss (G″) shear modulus of the hybrid electrolyte at 30° C. Throughout the frequency window, G′ is much greater than G″ and both moduli are independent of the frequency. These are hallmarks of elastic solids. (This noise in the G″ data are due to the fact that G′>>G″, i.e., the out-of-phase stress signal is very weak compared to the in-phase stress signal). Interpretation of the measured value of G′ in terms of microstructure is nontrivial because of the fact that the strain is expected to be localized in the polymeric phase. The PFPE-diol is a viscous liquid with room temperature viscosity of 0.12 Pa s. The shear modulus of the hybrid electrolyte is 2.6 MPa, three orders of magnitude lower than that of a glass sulfide reported by Sakuda et al. which exhibited a shear modulus of 5.9 GPa (sample prepared with a molding pressure of 360 MPa) (Sakuda, A.; Hayashi, A.; Takigawa, Y.; Higashi, K.; Tatsumisago, M. J. Ceram. Soc. Jap. 2013, 121, 946-949). The composite electrolyte thus has drastically improved the adhesive properties of the electrolyte with a relatively minor effect on ionic conductivity

### Example 3

### AC Impedance Measurements

Aluminum symmetric cells were assembled in the glovebox using the inorganic sulfide glass or the hybrid as electrolytes. Glass and hybrid pellets were obtained in a pneumatic cold (57 MPa and 23 MPa, respectively). After ball milling, the glass powder was placed in a pellet die between two mirror-polished aluminum electrodes. The diameter and thickness of the pellets were 13 mm and about 1 mm, respectively. The aluminum current collector tabs are placed on each electrode. Hybrid electrolyte membranes (thickness about 250 μm) were obtained using a manual press. The hybrid electrolyte powder from the ball mill was placed at the center of an insulating spacer in the press with a 3.17 mm diameter central hole, and two mirror-polished aluminum electrodes to ensure good contact between the electrodes and the electrolyte. The press was heated to 90° C. for 5 seconds. Aluminum current collector tabs are placed on each electrode. Finally, both pellets and hybrid membranes were vacuum sealed in a pouch bag to isolate it from air. Impedance spectroscopy measurements were performed using a VMP3 (Bio-Logic) with an ac amplitude of 50 mV in the frequency range 1 MHz-1 Hz. Impedance spectra were recorded at 10° C. intervals during heating and cooling scans in the temperature, T, range of 27° C. and 120° C. The ionic conductivity, a, of the conducting phase in the glass electrolyte or hybrid electrolyte is calculated from the measured sample thickness, 1, the cross-sectional area S of the spacer, and electrolyte resistance Rₑₗ·σ(T) is given by:

σ(T)=l/(S*Rₑₗ(T)) (1)

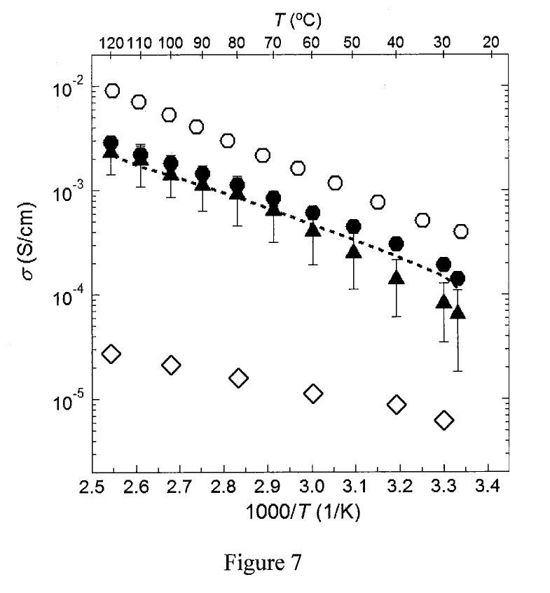

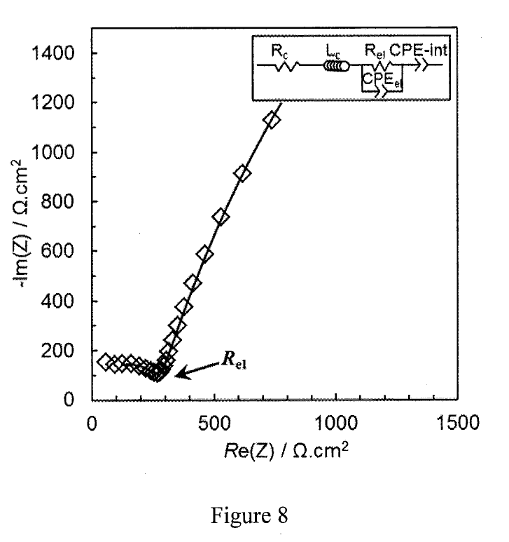

The temperature-dependence of the ionic conductivity (σ) of the four electrolytes listed in FIG. 1b is shown in FIG. 7. Typical ac impedance spectrum obtained from the hybrid electrolyte is shown in FIG. 8. The spectrum is dominated by a single relaxation process. The conductivity of a sulfide glass reported by Minami et al. is also shown in FIG. 7 (Minami, K.; Hayashi, A.; Tatsumisago, M. J. Electrochem. Soc. 2010, 157, A1296-A1301). The glass obtained by Minami et al. presents a conductivity that is a factor of 2.5 larger than that of the sulfide glass pellet. It is likely that this is due to the differences in pressure used to densify the samples. The ionic conductivity of the sulfide glass is higher than that of the PFPE-diol/LiTFSI liquid electrolyte by a factor that ranges from 20 to 100. The conductivity of the hybrid membrane is only a factor of 0.4 to 0.8 lower than that of the sulfide glass. In an attempt to predict the ionic conductivity of the hybrid, the following equation was used (ignoring any tortuosity):

σ_{calc}=φ_{glass}σ_{glass}+φ_{PFPE-diol/LiTFSI}σ_{PFPE-diol/LiTFSI} (2)

where φ_{glass}, the volume fraction of the sulfide glass is 0.76, and φ_{PFPE-diol/LiTFSI}, the volume fraction of the PFPE-diol/LiTFSI electrolyte is 0.24 (based on glass density, d_{glass}=1.9 g/cm3 and PFPE-diol/LiTFSI density, d_{PFPE-diol/LiTFSI}=1.8 g/cm3). As FIG. 7 shows, the values of ionic conductivity predicted are very similar to those obtained experimentally. It is evident that a unique solid electrolyte that exhibits ionic conductivity of 10⁻⁴ S/cm at 30° C. was obtained in spite of the fact that it contains 23 wt. % polymer.

### Example 4

### Transference Number Measurements

For transference number measurements, lithium symmetric cells were prepared by hand-pressing of hybrid membrane electrolytes between two lithium metal chips (250 μm). Nickel current collector tabs are placed on each lithium metal electrode and the cells were vacuum sealed in a pouch bag. Steady state technique was used to estimate the lithium transference number, t⁺, at a temperature of 30° C. (Wong D H, et al. (2014) Nonflammable perfluoropolyether-based electrolytes for lithium batteries. Proc Natl Acad Sci USA 111(9):3327-3331). This method combines dc polarization and ac impedance spectroscopy. An initial ac impedance measurement is performed to determine the initial interfacial resistance, Rᵢₙₜ⁰, which is followed by a chronoamperometry using a dc potential, ΔV, of 80 mV to record the current evolution from its initial value, I⁰, until a steady current, I^{∞} is obtained. At this point, ac impedance spectroscopy is used to get the interfacial resistance, Rᵢₙₜ^{∞}·t+ is calculated by:

$${t}^{+} = \frac{{I}^{∞} ( Δ V - {I}^{0} {R}_{int}^{0} )}{{I}^{0} ( Δ V - {I}^{∞} {R}_{int}^{∞} )} \qquad ( 3 )$$

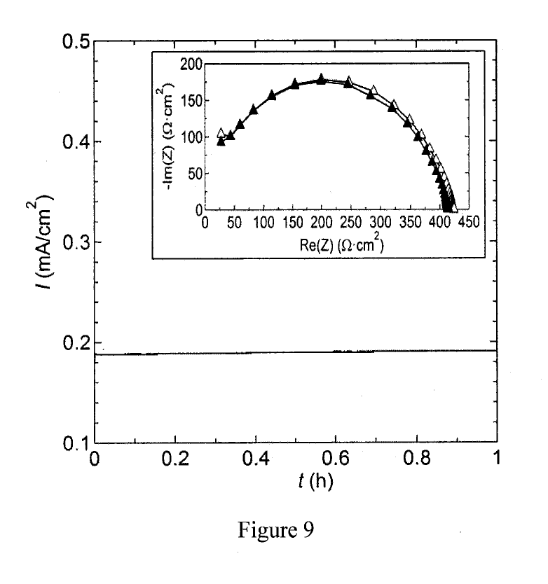

It is important to establish that the introduction of PFPE-diol/LiTFSI does not reduce the single-ion-conduction property of the composite electrolyte. This property is quantified by the cation transference number, the fraction of the total current carried by the cation. In single-ion conducting electrolytes, the cation transference number is unity due to the lack of mobility of the anion. Ohm's law should be observed in the limit of small dc potentials in a single-ion-conductor. On the other hand, in conventional electrolytes comprising two mobile charge carriers, concentration polarization will lead to large deviations from Ohm's law. The hybrid membrane electrolyte exhibits behavior similar to that of a single-ion-conductor. FIG. 9 shows the current profile over time during the 80 mV polarization while the inset represents the initial ac impedance spectra and the one recorded after 1 h. The measured total resistance after 1 h was 5215Ω and the measured current density, iₘ, was 1.91×10⁻¹ mA·cm⁻². The current density expected from Ohm's law, i₀, is 1.94×10⁻¹ mA·cm⁻² which gives iₘ/i₀=0.99. The lithium transference number, t+, of the hybrid electrolyte is estimated as 0.99, i.e., most of the current in the hybrid membrane electrolyte is carried by Li+.

### Example 5

### Electrochemical Stability

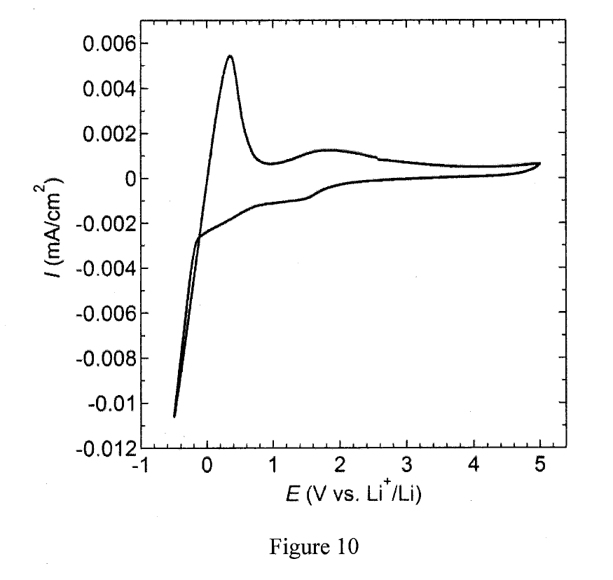

The electrochemical stability of the hybrid membrane was investigated by cyclic voltammetry as shown FIG. 10. The measurements were performed at 30° C. in the potential range in between −0.5 and 5.0 V (vs Li⁺/Li) at a scan rate of 1 mV/s. The low potential current corresponds to the reduction and oxidation of the Li⁺/Li⁰ couple, where lithium ion is reduced into Li metal at negative potentials and then stripped from the lithium metal electrode during the subsequent oxidation at 0.3 V (Sylla, S.; Sanchez, J.-Y.; Armand, M. Electrochimica Acta 1992, 37, 1699). Throughout 1.5 to 5 V potential range, the current density remains low indicating that the hybrid electrolyte is stable up to 5 V. It is thus expected that the hybrid electrolyte is suitable to the use in a lithium battery comprising a high-potential positive active material such as lithium nickel manganese cobalt oxide (NMC).

### Example 6

### X-Ray Absorption Spectroscopy (XAS) Measurements

One potential application of these hybrid solid electrolytes is for lithiumsulfur (Li—S) batteries, which are known to suffer from the issue of lithium polysulfide dissolution. Lithium polysulfide reaction intermediates (Li₂Sₓ, 2≦x≦8) formed during the Li—S charge/discharge reaction processes are highly soluble in many battery electrolytes. Thus, after their formation, polysulfides may diffuse out of the cathode and into the electrolyte separator causing capacity to fade, leading to degradation reactions at the lithium anode. Solid, inorganic electrolytes have become an increasingly popular approach to resolve this issue, as they prevent polysulfide dissolution while allowing for the passage of lithium ions (Lin, Z.; Liu, Z.; Fu, W.; Dudney, N J; Liang, C. Angew Chem Int Ed 2013, 52(29):7460-7463).

In recent studies, X-ray absorption spectroscopy (XAS) at the sulfur K-edge has been used to detect the presence of lithium polysulfide intermediates in Li—S battery electrolytes (Wujcik K H et al. Journal of The Electrochemical Society 2014, 161(6):A1100-A1106; Pascal T A et al. The Journal of Physical Chemistry Letters 2014, 5(9):1547-1551). The benefit of XAS is that it is an element-specific spectroscopic probe of both the electronic structure and local environment surrounding sulfur atoms. The spectra for lithium polysulfide dianions are characterized by two spectral features: a main edge peak at 2472.6 eV attributed to internal, neutrally charged sulfur, and a pre-edge peak at 2471.0 eV, due to the charged, terminal sulfur atoms (Pascal T A et al. The Journal of Physical Chemistry Letters 2014, 5(9):1547-1551). These distinguishing features allow one to use XAS to determine whether or not polysulfides are present in the medium being probed.

X-ray absorption spectroscopy was performed at beamline 4-3 at the Stanford Synchrotron Radiation Lightsource (SSRL). Preliminary work was performed at beamline 9.3.1 of the Advanced Light Source (ALS). Samples were transferred from an argon filled glovebox to the beamline in an air-tight sample holder with a 3 μm thick Mylar film window that enables X-rays to access the sample. Samples were measured in fluorescence mode using a 4-element silicon drift Vortex detector. The beamline energy was calibrated using sodium thiosulfate, setting the first peak's maximum intensity to 2472.02 eV. Spectra were taken over the range of 2440 to 2575 eV with an energy resolution as low as 0.08 eV in the area of the absorption edge. Three consecutive scans were taken for each sample, without any movement of the beam spot location between scans, and then averaged for further data analysis. X-ray spectra were normalized and background subtracted using SIXPACK.

To test whether or not polysulfide species are soluble in the hybrid electrolyte, a hybrid pellet was pressed against a solid polymer electrolyte loaded with Li₂S₈, a polysulfide molecule whose solubility and diffusivity are representative of all other lithium polysulfide species. The polymer electrolyte was a polystyreneb-poly(ethylene oxide) (SEO) copolymer and solubility of Li₂S₈ in this electrolyte was studied by Wujcik et al. (Wujcik K H et al. Journal of The Electrochemical Society 2014, 161(6):A1100-A1106). An polystyrene-b-poly(ethylene oxide) (SEO) diblock copolymer was synthesized on a high vacuum line via sequential anionic polymerization (Singh M, et al. Macromolecules 2007, 40(13):4578-4585), having polystyrene and poly(ethylene oxide) block molecular weights of 247 kg/mol and 116 kg/mol, respectively. The two solids were contacted by hand-pressing at 75° C. A small piece of the hybrid pellet was taken, and XAS was performed on the side of the pellet that was in direct contact with the SEO/Li₂S₈ membrane. Similarly, sulfide glass pellets were also exposed to SEO/Li₂S₈. Data was obtained after three days of exposure time. XAS at the sulfur K-edge was performed on glass and hybrid pellets after exposure to Li₂S₈. XAS spectra were also taken of glass and hybrid pellets that were not exposed to Li₂S₈. These spectra serve as backgrounds. It should be noted that both glass and hybrid samples contain sulfur.

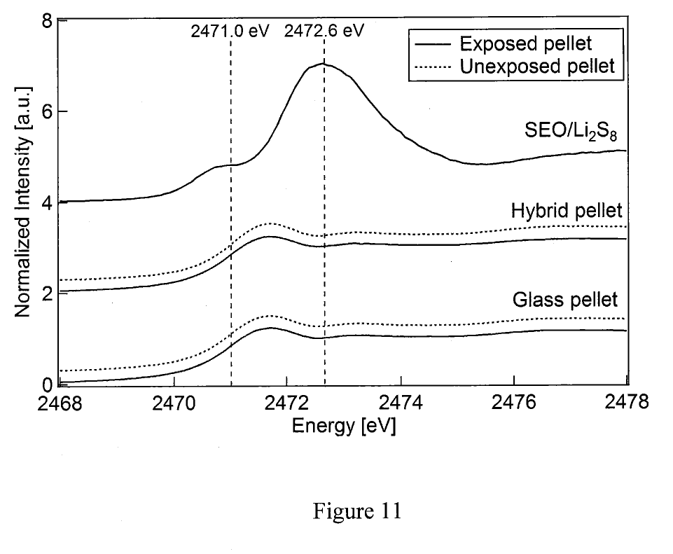

FIG. 11 shows the sulfur K-edge spectra of Li₂S₈ obtained by performing XAS on a film of SEO that contained Li₂S₈. If Li₂S₈ were present in the pellets, the resulting spectrum for each exposed pellet would be a linear combination of the Li₂S₈ and the unexposed pellet spectra. The spectra for the unexposed and exposed pellets are identical for both the hybrid and glass pellets. This indicates that neither the hybrid nor the glass pellets contain Li₂S₈. The exclusion of Li₂S₈ from hybrid electrolyte may, at first, seem counterintuitive due to the presence of PFPE. Note however that solubility of lithium-containing salts in PFPE is driven by the fluorinated anions that are absent in lithium polysulfides (Wong, D. H. C.; Thelen, J. L.; Fu, Y.; Devaux, D.; Pandya, A. A.; Battaglia, V. S.; Balsara, N. P.; DeSimone, J. M. PNAS 2014, 111, 3327-3331). According to the data in FIG. 11, the hybrid electrolytes would be ideally suited for lithium-sulfur cells due to the insolubility of the lithium polysulfide intermediates.

The foregoing is illustrative of the present invention, and is not to be construed as limiting thereof. The invention is defined by the following claims, with equivalents of the claims to be included therein.

That which is claimed is:

1. A solid electrolyte composition, comprising:
(a) a composite comprising an inorganic solid electrolyte bonded to an organic fluoropolymer, wherein the inorganic solid electrolyte conducts alkali ions; and
(b) optionally, an alkali metal salt.

2. The solid electrolyte composition of claim 1, wherein the organic fluoropolymer is an ion-conducting fluoropolymer.

3. The solid electrolyte composition of claim 1, wherein a cation transference number of the solid electrolyte composition is at least 0.9.

4. The solid electrolyte composition of claim 1, wherein a cation transference number of each of the inorganic solid electrolyte and the organic fluoropolymer is at least 0.9.

5. The solid electrolyte composition of claim 1, wherein said composite is included in said composition in an amount of from 90 to 99.5 percent by weight; and said alkali metal salt is included in said composition in an amount of from 0.5 to 10 percent by weight.

6. The solid electrolyte composition of claim 2, wherein the ion-conducting fluoropolymer comprises a compound selected from the group consisting of Formula I, Formula II, and mixtures thereof, wherein:
R—R_{f}—R (I)
R—R_{f} (II)
each R is independently selected from the group consisting of —OH, —COOH, —COOR′, or —OCOOR′;
R_{f} comprises a fluoropolymer segment; and
each R′ is an independently selected hydrogen atom or aliphatic, aromatic, or mixed aliphatic and aromatic group.

7. The solid electrolyte composition of claim 1, wherein the solid electrolyte composition includes the organic fluoropolymer in an amount at least 10% by weight.

8. The solid electrolyte composition of claim 1, wherein the solid electrolyte composition includes the organic fluoropolymer in an amount at least 15% by weight.

9. The solid electrolyte composition of claim 1, wherein the inorganic solid electrolyte is covalently bonded to the organic fluoropolymer.

10. The solid electrolyte composition of claim 1, wherein the inorganic solid electrolyte comprises one of a perovskite, a garnet, a thio-LISICON, a NASICON, a glass-ceramic, a sodium super ionic conductor, an oxide glass or a sulfide glass.

11. The solid electrolyte composition of claim 10, wherein the perovskite comprises Li₃ₓLa_{(2/3)-x}TiO₃,
wherein the garnet comprises Li₇La₃Zr₂O₁₂,
wherein the thio-LISICON comprises Li₁₀SnP₂S₁₂,
wherein the NASICON comprises Li_{1.3}Al_{0.3}Ti_{1.7}(PO₄)₃,
wherein the sodium super ionic conductor comprises Na₁₊ₓZr₂SiₓP₃₋ₓO₁₂ or 50Na₂S-50P₂S₅,
wherein the oxide glass comprises Li₃BO₃—Li₂SO₄, Li₂O—P₂O₅ or Li₂O—SiO₂, and
wherein the sulfide glass comprises Li₂S—SiS₂, Li₂S—P₂S₅ or LiI—Li₂S—B₂S₃.

12. The solid electrolyte composition of claim 1, wherein the inorganic solid electrolyte comprises sulfide glass comprising 75Li₂S.25P₂S₅.

13. The solid electrolyte composition of claim 1, wherein the alkali metal salt is included in the solid electrolyte composition and comprises lithium bis(trifluoromethanesulfone)imide (LiTFSI).

14. The solid electrolyte composition of claim 1, wherein the solid electrolyte composition is a flexible solid.

15. The solid electrolyte composition of claim 1, wherein the solid electrolyte composition is in the form a film.

16. The solid electrolyte composition of claim 1, wherein the solid electrolyte composition does not solvate polysulfides.

17. The solid electrolyte composition of claim 1, wherein the solid electrolyte composition has a glass-transition temperature T_{g} between −120° C. and −20° C.

18. A battery, comprising:
(a) an anode;
(b) a cathode; and
(c) a solid electrolyte composition operatively associated with said anode and cathode, wherein said solid electrolyte composition comprises the composition of claim 1.
